(19) United States
(12) Patent Application Publication
(10) Pub. No.: US 2025/0306331 A1
(43) Pub. Date: Oct. 2, 2025

(54) LENS UNIT

(71) Applicant: NIDEC INSTRUMENTS CORPORATION, Nagano (JP)

(72) Inventor: Takuya KASAHARA, Nagano (JP)

(21) Appl. No.: 19/087,585

(22) Filed: Mar. 24, 2025

(30) Foreign Application Priority Data
Mar. 29, 2024 (JP) 2024-055355

(51) Int. Cl. G02B 7/02

(52) U.S. Cl. CPC G02B 7/026; G02B 7/021

(57) ABSTRACT

A lens unit comprising: a first lens that is a resin-made lens; and a lens holder that holds the first lens, wherein the first lens has a cylindrical rib protruding toward an image side, the rib is formed outside an effective diameter of an image-side surface of the first lens and concentrically with an optical axis, an O-ring is mounted on an outer peripheral surface of the rib, the O-ring is placed between the outer peripheral surface of the rib and an inner peripheral surface of the lens holder, and a deformation preventing portion that is in contact with an inner peripheral surface of the rib and prevents deformation of the rib is provided in the lens holder.

### CROSS REFERENCE TO RELATED APPLICATION

The present invention claims priority under 35 U.S.C. § 119 to Japanese Application No. 2024-055355 filed Mar. 29, 2024, the entire content of which is incorporated herein by reference.

### BACKGROUND

### Field of the Invention

At least an embodiment of the present invention relates to a lens unit, and more particularly, to a sealing structure for a lens unit.

Description of the Related Documents Japanese Unexamined Patent Publication No. 2018-54798 discloses a lens unit in which an O-ring is compressed in a radial direction by an outer peripheral surface of a plastic lens and an inner peripheral surface of a lens holder.

A plastic lens has a lower hardness than a glass lens and is easily scratched. When an O-ring is disposed between the lower surface (image-side surface) of the plastic lens and the upper surface (object-side surface) of the lens holder, and the lens is fixed by caulking while the surface of the lens is pressed by a jig, the surface of the lens may be damaged. Therefore, in the sealing of the plastic lens, a structure in which the O-ring is compressed by the outer peripheral surface of the lens and the inner peripheral surface of the holder is generally adopted. On the other hand, a plastic lens is more likely to be deformed than a glass lens, and the shape of the plastic lens may be distorted when the plastic lens is compressed by the restoring force and repulsive force of the O-ring.

In view of the above problems, an object of at least an embodiment of the present invention is to prevent deformation of a plastic lens due to a restoring force and a repulsive force of an O-ring.

### SUMMARY

In order to solve the above problems, a lens unit of an aspect of at least an embodiment of the present invention includes: a first lens that is a resin-made lens; and a lens holder that holds the first lens, wherein the first lens has a cylindrical rib protruding toward an image side, the rib is formed outside an effective diameter of an image-side surface of the first lens and concentrically with an optical axis, an O-ring is mounted on an outer peripheral surface of the rib, the O-ring is placed between the outer peripheral surface of the rib and an inner peripheral surface of the lens holder, and a deformation preventing portion that is in contact with an inner peripheral surface of the rib and prevents deformation of the rib is provided in the lens holder.

Since the rib compressed by the O-ring is supported from the inside by the deformation preventing portion, distortion of the first lens, which is a plastic lens, can be suppressed.

In addition, it is preferable that a first inclined surface that is a surface inclined radially outward from an object side toward the image side is provided on an inner peripheral surface of the rib, and a second inclined surface that is a surface having a complementary shape to be fitted to the first inclined surface is provided on a surface of the deformation preventing portion facing the first inclined surface. At this time, it is more preferable that a position of the first lens in the optical axis direction is determined by the first inclined surface being in contact with the second inclined surface. Since the rib and the deformation preventing portion are fitted to each other by the inclined surfaces thereof, a gap (that is, room for deformation) between the rib and the deformation preventing portion is eliminated, and the rib and the deformation preventing portion can be brought into close contact with each other from the beginning.

Further, it is preferable that the length of the rib in the optical axis direction is 1.5 times or less the wire diameter of the O-ring. This is because the longer the rib is, the more easily the tip portion of the rib is deformed.

Further, it is preferable that the deformation preventing portion faces an inner peripheral surface of the rib at a position of the O-ring in the optical axis direction. It is possible to more effectively prevent the deformation of the rib by supporting the portion of the rib that directly receives the restoring force and the repulsive force of the O-ring by the deformation preventing portion.

In addition, it is preferable that the first lens has a flange-shaped portion that extends radially outward from the rib, and the O-ring is mounted on a base end portion that is an end portion on a root side of the rib. By mounting the O-ring to the portion of the rib having the highest rigidity, the deformation of the rib can be prevented more effectively.

Further, it is preferable that the lens unit of at least an embodiment of the present invention further comprises a second lens disposed closer to the image side than the first lens, wherein the deformation preventing portion is a resin-made cylindrical portion, the second lens is fixed by caulking an end portion on an object side of the deformation preventing portion, and the end portion on the object side of the deformation preventing portion is thinner than other portions of the deformation preventing portion, or a notch or a cut is provided in a peripheral surface of the end portion on the object side of the deformation preventing portion. Since the deformation preventing portion of at least an embodiment of the present invention is a supporting portion having rigidity capable of preventing the deformation of the rib, the deformation preventing portion is formed to be thicker and larger than a supporting portion that merely holds the second lens. That is, an additional device for fixing the second lens by caulking is required for the deformation preventing portion. Therefore, by intentionally thinning only the end portion of the deformation preventing portion or forming a notch or a cut in the end portion, it is possible to achieve both the rigidity for preventing the deformation of the rib and the easiness of fixing of the second lens by caulking.

Further, at least an object-side surface of the first lens may be coated with an anti-abrasion film, an anti-reflection film, or a water-repellent film. According to at least an embodiment of the present invention, since deformation of the first lens is prevented, cracking and peeling of the surface coating due to the deformation are also prevented.

As described above, according to the lens unit of at least an embodiment of the present invention, it is possible to prevent the plastic lens from being deformed by the restoring force and the repulsive force of the O-ring.

### BRIEF DESCRIPTION OF THE DRAWINGS

Embodiments will now be described, by way of example only, with reference to the accompanying drawings which are meant to be exemplary, not limiting, and wherein like elements are numbered alike in several figures, in which:

FIG. 1 is a side sectional view showing an internal structure of a lens unit 50;

FIGS. 2A and 2B are views showing a sealing structure of the lens unit 50; and

FIGS. 3A and 3B are schematic views showing a structure of a second caulking portion 26.

### DETAILED DESCRIPTION

Hereinafter, embodiments of a lens unit according to at least an embodiment of the present invention will be described with reference to the drawings. A lens unit 50 described below is a compact lens assembly incorporated in various devices. A front lens of the lens unit 50 is made of plastic, and an O-ring is mounted on the outer peripheral surface of the front lens to secure airtightness in the unit. The lens unit 50 is provided with a deformation preventing portion that supports the portion of the front lens to be compressed by the O-ring from the inside, thereby preventing the deformation of the front lens. Hereinafter, this feature and additional features thereof will be described based on embodiments.

### Configuration Overview

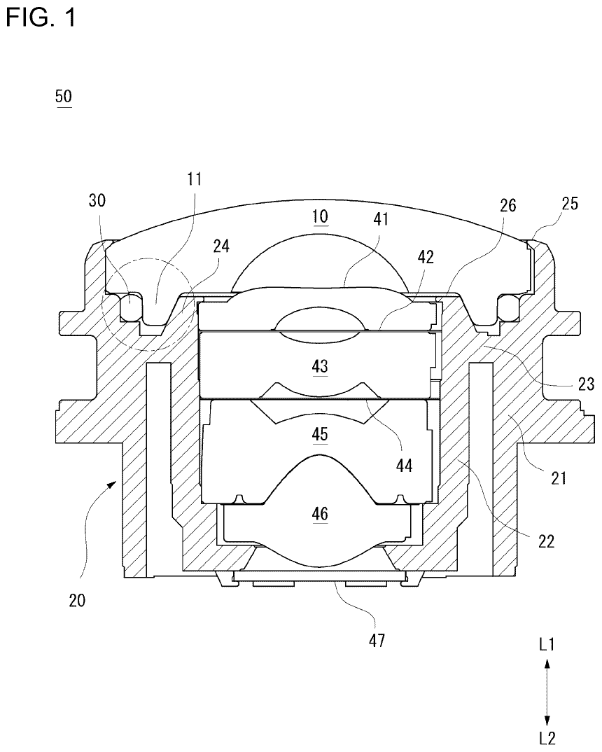

FIG. 1 is a side sectional view showing an internal structure of the lens unit 50. As shown in FIG. 1, the lens unit 50 is composed of a plurality of lenses arranged from the object side toward the image side, and a lens holder 20 that holds the plurality of lenses. A vertical line L1-L2 shown in FIG. 1 indicates an optical axis direction, where L1 is an object side and L2 is an image side. In the following description, “radial direction” and “horizontal” refer to directions orthogonal to the optical axis direction L1-L2.

The first lens 10 is a lens that is disposed closest to the object side among the lenses held by the lens holder 20 and has negative power in which a convex curved surface is formed on the object side and a concave curved surface is formed on the image side L2. A second lens 41 is a lens that is disposed on the image side of the first lens 10, has a smaller lens diameter than the first lens 10, and has a negative power. A third lens 43 having a positive power, a fourth lens 45 having a negative power, and a fifth lens 46 having a positive power are arranged in this order on the image side of the second lens 41. The fourth lens 45 and the fifth lens 46 constitute a cemented lens having a positive power. A light shielding sheet 42 is disposed between the second lens 41 and the third lens 43, and a diaphragm 44 is disposed between the third lens 43 and the fourth lens 45. Further, an infrared filter 47 is disposed on the image side of the fifth lens 46. These lenses constitute a single-focus wide-angle lens of a reverse telephoto type (so-called retrofocus type) including five lenses in four groups. Note that a plastic lens is adopted for these lenses from the viewpoint of excellent workability and economical efficiency of the lens.

The lens holder 20 is a resin-made lens frame that constitutes a lens barrel. The lens holder 20 has a double cylinder structure including an outer cylinder 21 and an inner cylinder 22, and the outer cylinder 21 and the inner cylinder 22 are connected to each other by a connecting portion 23 provided in the vicinity of an opening of the inner cylinder 22 on the object side. The first lens 10 is held by the outer cylinder 21 of the lens holder 20, and the other lenses and filters are held by the inner cylinder 22.

The peripheral edges of the first lens 10 and the second lens 41 are fixed to the lens holder 20 by thermal caulking for positioning and retaining the lenses. More specifically, the peripheral edge of the first lens 10 is fixed by thermal caulking of a first caulking portion 25 provided at an end portion of the outer cylinder 21 on the object side, and the peripheral edge of the second lens 41 is fixed by thermal caulking of a second caulking portion 26 provided at an end portion of the inner cylinder 22 on the object side.

A cylindrically-shaped rib formed concentrically with the optical axis is provided outside the effective diameter of the first lens 10 on the image-side surface of the first lens 10. The rib 11 projects toward the image side, and an O-ring 30 is mounted on the outer peripheral surface of the rib 11. The O-ring is compressed in the radial direction by the outer peripheral surface of the rib 11 and the inner peripheral surface of the outer cylinder 21 to seal the lens unit 50. Further, the object-side surface of the first lens 10 is coated with an anti-abrasion film (so-called hard coat), an anti-reflection film (so-called AR coat), and a water-repellent film or a hydrophilic film in this order.

Note that the lens configuration and use, the structure of the lens holder, the power of the lens, the shape of the lens surface, and the like of the lens unit of at least an embodiment of the present invention are not limited to the aspect of the lens unit 50. As long as the lens unit includes the first lens 10 that is a plastic lens, the rib 11 that is compressed by the O-ring 30, and a below-described deformation preventing portion, other configurations and structures may be arbitrarily changed.

### Sealing Structure

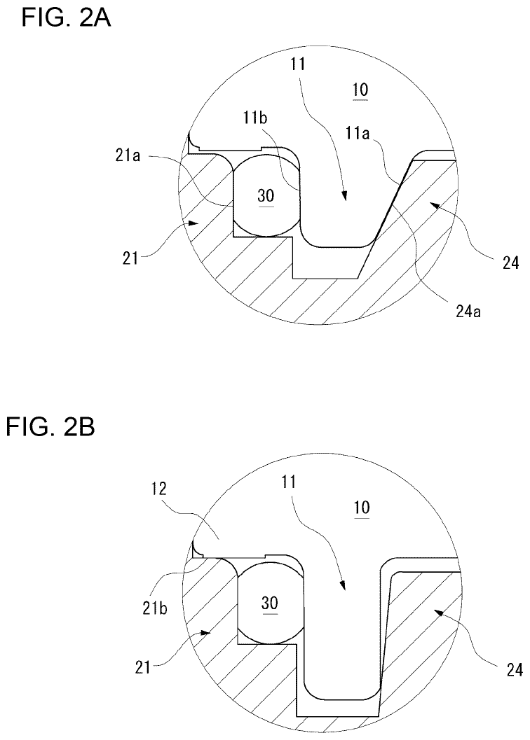

FIGS. 2A and 2B are views showing a sealing structure of the lens unit 50. FIG. 2A is an enlarged view of a portion surrounded by an alternate long and short dash line in FIG. 1, and FIG. 2B is a schematic view showing a modification of the sealing structure of this embodiment. Hereinafter, the sealing structure of the lens unit 50 will be described with reference to FIGS. 2A and 2B.

As described above, the lens unit 50 of the present embodiment includes the first lens 10 that is a resin-made front lens, and the resin-made lens holder 20 that holds the plurality of lenses including the first lens 10. The first lens 10 is provided with the cylindrically-shaped rib 11 projecting to the image side, and the O-ring 30 is mounted on an outer peripheral surface 11b of the rib 11. The O-ring 30 is placed between the outer peripheral surface 11b of the rib 11 and the inner peripheral surface 21a of the outer cylinder 21 of the lens holder 20 in the radial direction. That is, the rib 11 is always compressed by the restoring force of the O-ring 30 stretched at the time of mounting. Further, since the O-ring 30 is compressed between the rib 11 and the lens holder 20, the rib 11 is also compressed by the repulsive force of the O-ring 30. A plastic lens is more likely to be deformed than a glass lens, and the shape of the plastic lens may be distorted when the lens is compressed by the restoring force and repulsive force of the O-ring 30. Therefore, the lens unit 50 is provided with a deformation preventing portion 24 for preventing the deformation of the rib 11.

The deformation preventing portion 24 of this embodiment is a part of the lens holder 20, and is a cylindrically-shaped portion that comes into contact with the inner peripheral surface 11a of the rib 11. As will be described later, the deformation preventing portion 24 of this embodiment also serves as a supporting portion of the second lens 41. In the lens unit 50, the deformation preventing portion 24 supports the rib 11 that is compressed by the O-ring 30 from the inside of the rib 11, thereby preventing the deformation of the first lens 10 that is a plastic lens. Note that the deformation preventing portion 24 may be prepared as a component separate from the lens holder 20.

Further, as shown in FIG. 2A, the inner peripheral surface 11a of the rib 11 of the present embodiment constitutes a first inclined surface that is a surface inclined radially outward from the object side toward the image side. Further, an outer peripheral surface 24a of the deformation preventing portion 24 facing the inner peripheral surface 11a of the rib 11 constitutes a second inclined surface that is a surface having a complementary shape to be fitted to the first inclined surface. In this embodiment, the entire inner peripheral surface 11a of the rib 11 is the first inclined surface, and the entire outer peripheral surface 24a of the deformation preventing portion 24 facing the inner peripheral surface 11a is the second inclined surface. The position of the first lens 10 in the optical axis direction is determined by the inner peripheral surface 11a (first inclined surface) of the rib 11 coming into contact with the outer peripheral surface 24a (second inclined surface) of the deformation preventing portion 24. In the lens unit 50 of this embodiment, by fitting the rib 11 and the deformation preventing portion 24 to each other to position the first lens 10 in the optical axis direction, the rib 11 and the deformation preventing portion 24 are brought into close contact with each other. In other words, the gap between the rib 11 and the deformation preventing portion 24, that is, the room for deformation of the first lens 10 is removed from the beginning of the assembly.

Further, in the lens unit 50 of this embodiment, the length of the rib 11 in the optical axis direction is substantially the same as the wire diameter of the O-ring 30. Therefore, the O-ring 30 is inevitably mounted to the base end portion that is the end portion on the root side (object side) of the rib 11. In addition, the first lens 10 of the present embodiment has a flange portion 12 that is a collar portion extending radially outward from the position of the rib 11. The flange portion 12 facilitates the positioning of the O-ring 30 and prevents the O-ring 30 from being displaced. Further, the deformation preventing portion 24 is in contact with the inner peripheral surface 11a of the rib 11 at the position of the O-ring 30 in the optical axis direction. As described above, in the lens unit 50 of this embodiment, the O-ring 30 is mounted to the portion of the rib 11 having the highest rigidity, that is, the root portion thereof, and the portion directly receiving the restoring force and the repulsive force of the O-ring 30 is supported by the deformation preventing portion 24 from the inside, thereby the deformation of the rib 11, that is, the distortion of the first lens 10 is more effectively prevented.

Note that the fitting method of the rib 11 and the deformation preventing portion 24 is not limited to the aspect of the lens holder 50 of the present embodiment. For example, the first inclined surface and the second inclined surface may be provided on parts of the inner peripheral surface 11a and the outer peripheral surface 24a that are the facing surfaces of the rib 11 and the deformation preventing portion 24. Further, as shown in FIG. 2B, the inner and outer surfaces of the rib 11 may be vertical surfaces. The length of the rib 11 in the optical axis direction is also arbitrary, but is preferably set to about 1.5 times or less the wire diameter of the O-ring 30 in consideration of the rigidity of the rib 11. Further, the positioning of the first lens 10 in the optical axis direction may be performed by placing the flange portion 12 on a placement surface 21b that is a horizontal surface provided on the outer cylinder 21 of the lens holder 20.

As described above, in the lens unit 50 of the present embodiment, the rib 11 of the first lens 10 is supported from the inside by the deformation preventing portion 24, thereby preventing the deformation of the first lens 10 due to the restoring force and the repulsive force of the O-ring 30. This also prevents cracking or peeling of a hard coat or the like coated on the first lens 10.

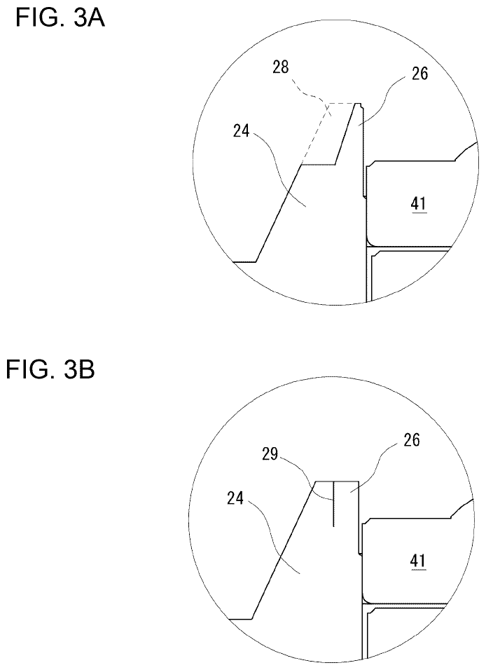

Structure of second caulking portion FIGS. 3A and 3B are schematic views showing a structure of the second caulking portion 26. As described above, the second lens 41 of the lens unit 50 is fixed by thermal caulking of the second caulking portion 26 that is a part of the deformation preventing portion 24. The deformation preventing portion 24 is a supporting portion having rigidity capable of preventing deformation of the rib 11. Therefore, the supporting portion is formed to be thicker and larger than a supporting portion that merely holds the second lens 41. That is, an additional device for fixing the second lens 41 by caulking is required for the deformation preventing portion 24.

As shown in FIG. 3A, the second caulking portion 26 of the present embodiment is formed to be thinner in a stepped shape than other portions of the deformation preventing portion 24. This can be considered that the portion of the notch portion 28 indicated by the broken line in FIG. 3A is cut out. Alternatively, as shown in FIG. 3B, a cut 29 may be formed in the second caulking portion 26. As a result, the deformation preventing portion 24 can achieve both the rigidity for preventing the deformation of the rib 11 and the easiness of the fixing of the second lens 41 by caulking.

### Other

Note that the present technology can be configured as follows.

(1)

A lens unit comprising:
a first lens that is a resin-made lens; and
a lens holder that holds the first lens, wherein
the first lens has a cylindrical rib protruding toward an image side,
the rib is formed outside an effective diameter of an image-side surface of the first lens and concentrically with an optical axis,
an O-ring is mounted on an outer peripheral surface of the rib, the O-ring is placed between the outer peripheral surface of the rib and an inner peripheral surface of the lens holder, and
a deformation preventing portion that is in contact with an inner peripheral surface of the rib and prevents deformation of the rib is provided in the lens holder.
   (2)

The lens unit according to (1), wherein
a first inclined surface that is a surface inclined radially outward from an object side toward the image side is provided on an inner peripheral surface of the rib, and
a second inclined surface that is a surface having a complementary shape to be fitted to the first inclined surface is provided on a surface of the deformation preventing portion facing the first inclined surface.
   (3)

The lens unit according to (2), wherein
a position of the first lens in the optical axis direction is determined by the first inclined surface being in contact with the second inclined surface.
   (4)

The lens unit according to any one of (1) to (3), wherein
a length of the rib in an optical axis direction is equal to or less than 1.5 times a wire diameter of the O-ring.
   (5)

The lens unit according to any one of (1) to (5), wherein
the deformation preventing portion faces an inner peripheral surface of the rib at a position of the O-ring in an optical axis direction.
   (6)

The lens unit according to (5), wherein
the first lens has a flange-shaped portion that extends radially outward from the rib, and
the O-ring is mounted on a base end portion that is an end portion on a root side of the rib.
   (7)

The lens unit according to any one of (1) to (6), further comprising
a second lens disposed closer to the image side than the first lens, wherein
the deformation preventing portion is a resin-made cylindrical portion,
the second lens is fixed by caulking an end portion on an object side of the deformation preventing portion, and
the end portion on the object side of the deformation preventing portion is thinner than other portions of the deformation preventing portion, or a notch or a cut is provided in a peripheral surface of the end portion on the object side of the deformation preventing portion.
   (8)

The lens unit according to (1) to (7), wherein
at least an object-side surface of the first lens is coated with an anti-abrasion film, an anti-reflection film, or a water-repellent film.

Although the embodiments of at least an embodiment of the present invention have been described above in detail, at least an embodiment of the present invention is not limited to the above-described embodiments, and various modifications can be made without departing from the scope of at least an embodiment of the present invention.

What is claimed is:

1. A lens unit comprising:
a first lens that is a resin-made lens; and
a lens holder that holds the first lens, wherein
the first lens has a cylindrical rib protruding toward an image side,
the rib is formed outside an effective diameter of an image-side surface of the first lens and concentrically with an optical axis,
an O-ring is mounted on an outer peripheral surface of the rib, the O-ring is placed between the outer peripheral surface of the rib and an inner peripheral surface of the lens holder, and
a deformation preventing portion that is in contact with an inner peripheral surface of the rib and prevents deformation of the rib is provided in the lens holder.

2. The lens unit according to claim 1, wherein
a first inclined surface that is a surface inclined radially outward from an object side toward the image side is provided on an inner peripheral surface of the rib, and
a second inclined surface that is a surface having a complementary shape to be fitted to the first inclined surface is provided on a surface of the deformation preventing portion facing the first inclined surface.

3. The lens unit according to claim 2, wherein
a position of the first lens in the optical axis direction is determined by the first inclined surface being in contact with the second inclined surface.

4. The lens unit according to claim 1, wherein
a length of the rib in an optical axis direction is equal to or less than 1.5 times a wire diameter of the O-ring.

5. The lens unit according to claim 1, wherein
the deformation preventing portion faces an inner peripheral surface of the rib at a position of the O-ring in an optical axis direction.

6. The lens unit according to claim 5, wherein
the first lens has a flange-shaped portion that extends radially outward from the rib, and
the O-ring is mounted on a base end portion that is an end portion on a root side of the rib.

7. The lens unit according to claim 1, further comprising
a second lens disposed closer to the image side than the first lens, wherein
the deformation preventing portion is a resin-made cylindrical portion,
the second lens is fixed by caulking an end portion on an object side of the deformation preventing portion, and
the end portion on the object side of the deformation preventing portion is thinner than other portions of the deformation preventing portion, or a notch or a cut is provided in a peripheral surface of the end portion on the object side of the deformation preventing portion.

8. The lens unit according to claim 1, wherein
at least an object-side surface of the first lens is coated with an anti-abrasion film, an anti-reflection film, a water-repellent film, or a hydrophilic film.

9. The lens unit according to claim 3, wherein
the deformation preventing portion faces an inner peripheral surface of the rib at a position of the O-ring in an optical axis direction.

10. The lens unit according to claim 9, wherein
the first lens has a flange-shaped portion that extends radially outward from the rib, and
the O-ring is mounted on a base end portion that is an end portion on a root side of the rib.

11. The lens unit according to claim 5, further comprising
a second lens disposed closer to the image side than the first lens, wherein
the deformation preventing portion is a resin-made cylindrical portion,
the second lens is fixed by caulking an end portion on an object side of the deformation preventing portion, and
the end portion on the object side of the deformation preventing portion is thinner than other portions of the deformation preventing portion, or a notch or a cut is provided in a peripheral surface of the end portion on the object side of the deformation preventing portion.

12. The lens unit according to claim 5, wherein
at least an object-side surface of the first lens is coated with an anti-abrasion film, an anti-reflection film, a water-repellent film, or a hydrophilic film.
